(19) United States
(12) Patent Application Publication
(10) Pub. No.: US 2024/0422047 A1
(43) Pub. Date: Dec. 19, 2024

(54) METHOD FOR SCHEDULING, APPARATUS, AND READABLE STORAGE MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 18/704,285

(22) PCT Filed: Oct. 25, 2021
(86) PCT No.: PCT/CN2021/126173

§ 371 Date: Apr. 24, 2024

(51) Int. Cl. H04L 27/26

(52) U.S. Cl. CPC H04L 27/2662; H04L 27/2675

(57) ABSTRACT

A method for scheduling includes: sending a maximum reception timing offset to a network device; determining N based on the maximum reception timing offset, where N is configured to denote a number of symbols; and transmitting no radio information in a first time period in a measurement process, where the first time period corresponds to a time period from an Nth symbol before a second time period to an Nth symbol after the second time period, and the second time period is a reference signal measurement time period corresponding to the measurement process.

### CROSS REFERENCE TO RELATED APPLICATIONS

The present application is a U.S. National Stage of International Application No. PCT/CN2021/126173, filed on Oct. 25, 2021, the contents of all of which are incorporated herein by reference in their entireties for all purposes.

### BACKGROUND OF THE INVENTION

A frequency range 2 (FR2) inter-band carrier aggregation (CA) scenario is introduced in a radio communication system, for example, a release-16 (Rel-16) new radio (NR) system. User equipment (UE) can receive downlink signals from different serving cells in an independent beam management (IBM) or common beam management (CBM) manner.

UE supporting IBM can use independent reception/transmission beams for reception/transmission of different serving cells. However, UE supporting CBM only can merely use the same reception/transmission beam for reception/transmission of different serving cells.

### SUMMARY OF THE INVENTION

The disclosure relates to the technical field of radio communication, and in particular to a method for scheduling, an apparatus, a device, and a readable storage medium.

In a first aspect, a method for scheduling is provided. The method is performed by user equipment (UE) and includes: sending a maximum reception timing offset to a network device; determining N based on the maximum reception timing offset, where N is configured to denote a number of symbols; and transmitting no radio information in a first time period in a measurement process, where the first time period corresponds to a time period from an Nth symbol before a second time period to an Nth symbol after the second time period, and the second time period is a reference signal measurement time period corresponding to the measurement process.

In a second aspect, a method for scheduling is provided. The method is performed by a network device and includes: receiving a maximum reception timing offset from user equipment; determining N based on the maximum reception timing offset, where N is configured to denote a number of symbols; and sending no downlink information to the user equipment in a first time period in a measurement process performed by the user equipment, where the first time period corresponds to a time period from an Nth symbol before a second time period to an Nth symbol after the second time period, and the second time period is a reference signal measurement time period corresponding to the measurement process.

In a third aspect, a communication apparatus is provided in the example of the disclosure. The communication apparatus includes a processor and a memory; where the memory is configured to store a computer program; and the processor is configured to implement the first aspect or any one of possible designs in the first aspect by executing the computer program.

In a fourth aspect, a communication apparatus is provided in the example of the disclosure. The communication apparatus includes a processor and a memory; where the memory is configured to store a computer program; and the processor is configured to implement the second aspect or any one of possible designs in the second aspect by executing the computer program.

In a fifth aspect, a non-transitory computer-readable storage medium is provided in the example of the disclosure. The non-transitory computer-readable storage medium stores an instruction (or referred to as a computer program or a program), where in response to being invoked and executed on a computer, the instruction causes the computer to perform the first aspect or any one of possible designs in the first aspect above.

In a sixth aspect, a non-transitory computer-readable storage medium is provided in the example of the disclosure. The non-transitory computer-readable storage medium stores an instruction (or referred to as a computer program or a program), where in response to being invoked and executed on a computer the instruction causes the computer to perform the second aspect or any one of possible designs in the second aspect above.

It should be understood that the above general description and the following detailed description are merely illustrative and explanatory, and cannot limit the disclosure.

### BRIEF DESCRIPTION OF DRAWINGS

The accompanying drawings described here are used for providing further understanding of examples of the disclosure as a constituent part of the disclosure. Examples of the disclosure and their descriptions serve to explain the examples of the disclosure, instead of limiting the examples of the disclosure improperly.

The accompanying drawings here are incorporated in the description as a constituent part of the description, illustrate examples conforming to the examples of the disclosure, and serve to explain the principles in the examples of the disclosure along with the description.

FIG. 1 is a schematic diagram of a communication system shown according to an example.

FIG. 2 is a schematic flowchart of a method for scheduling shown according to an example.

FIG. 3 is a schematic flowchart of a method for scheduling shown according to an example.

FIG. 4 is a schematic flowchart of a method for scheduling shown according to an example.

FIG. 5 is a schematic flowchart of a method for scheduling shown according to an example.

FIG. 6 is a schematic flowchart of a method for scheduling shown according to an example.

FIG. 7 is a structural diagram of a communication apparatus shown according to an example.

FIG. 8 is a structural diagram of another communication apparatus shown according to an example.

FIG. 9 is a structural diagram of another communication apparatus shown according to an example.

FIG. 10 is a structural diagram of another communication apparatus shown according to an example.

### DETAILED DESCRIPTION OF THE INVENTION

Examples of the disclosure will be further described with reference to the accompanying drawings and particular embodiments.

Examples will be described in detail here and are illustratively shown in the accompanying drawings. When the following description relates to the accompanying drawings, the same numbers in different accompanying drawings denote the same or similar elements unless indicated otherwise. The embodiments described in the examples below do not denote all embodiments consistent with the examples of the disclosure. On the contrary, the embodiments are merely instances of apparatuses and methods consistent with some aspects of the disclosure as recited in the appended claims.

The UE supporting CBM only may cause inter-symbol interference if the reception or transmission timing offset between the serving cells is longer than a length of a cycle prefix (CP). Thus, it is a pressing issue to address the inter-symbol interference.

As shown in FIG. 1, a method for scheduling according to an example of the disclosure may be applied to a radio communication system 100. The radio communication system 100 may include user equipment 101 and a network device 102. The user equipment 101 is configured to support carrier aggregation and may be connected to a plurality of carrier units of the network device 102, including one primary carrier unit and one or more secondary carrier units.

It should be understood that the radio communication system 100 may be applicable to a low-frequency scenario and a high-frequency scenario. Application scenarios of the radio communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, or a future evolved public land mobile network (PLMN) system, etc.

The user equipment (UE) 101 shown above may be a terminal, an access terminal, a terminal unit, a terminal station, a mobile station (MS), a remote station, a remote terminal, a mobile terminal, a radio communication device, a terminal proxy, or user equipment, etc. The user equipment 101 may have a radio transmitting and receiving function, perform communication (for example, radio communication) with one or more network devices of one or more communication systems, and accept network services provided by the network device. The network device here includes, but is not limited to, the network device 102 illustrated.

The user equipment 101 may be a cellular telephone, a cordless telephone, a session initiation protocol (SIP) telephone, a wireless local loop (WLL) station, a personal digital assistant (PDA) device, a handheld device having a radio communication function, a computation device or other processing devices connected to a radio modem, a vehicle-mounted device, a wearable device, user equipment in the future 5G network, or user equipment in a future evolved PLMN network, etc.

The network device 102 may be an access network device (or referred to as an access network site). The access network device means a device having a network access function, such as a radio access network (RAN) base station. The network device 102 may specifically include a base station (BS), or include a base station and a radio resource management device configured to control the base station. The network device 102 may further include a relay station (a relay device), an access point, and a base station in the future 5G network, a base station in the future evolved PLMN network, or an NR base station, etc. The network device 102 may be a wearable device or a vehicle-mounted device. The network device 102 may also be a communication chip having a communication module.

For example, the network device 102 includes, but is not limited to, a gnode B (gNB) in 5G, an evolved node B (eNB) in the LTE system, a radio network controller (RNC), a node B (NB) in a WCDMA system, a radio controller and a base station controller (BSC) in a CRAN system, a base transceiver station (BTS) in GSM system or CDMA system, a home base station (for example, a home evolved node B or a home node B (HNB)), a baseband unit (BBU), a transmitting and receiving point (TRP), a transmitting point (TP), or a mobile switching center, etc.

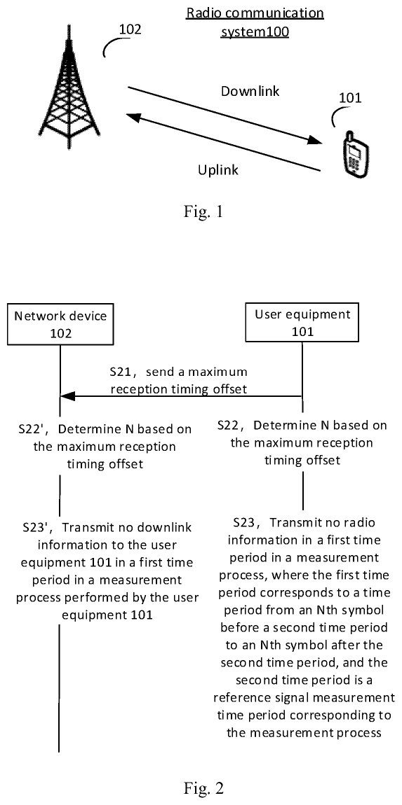

A method for scheduling is provided in an example of the disclosure. The method may be applied to the radio communication system 100. With reference to FIG. 2, a flowchart of a method for scheduling according to an example is shown. As shown in FIG. 2, the method includes steps S21, S22, S22′, S23 and S23′.
In S21, the user equipment 101 sends a maximum reception timing offset to the network device 102.
In S22, the user equipment 101 determines N based on the maximum reception timing offset, where N is configured to denote a number of symbols. In S22′, the network device 102 determines N based on the maximum reception timing offset, where N is configured to denote a number of symbols.
In S23, the user equipment 101 transmits no radio information in a first time period in a measurement process, where the first time period corresponds to a time period from an Nth symbol before a second time period to an Nth symbol after the second time period, and the second time period is a reference signal measurement time period corresponding to the measurement process. In S23′, the network device 102 transmits no downlink information to the user equipment 101 in a first time period in a measurement process performed by the user equipment 101. Where the first time period corresponds to a time period from an Nth symbol before a second time period to an Nth symbol after the second time period, and the second time period is a reference signal measurement time period corresponding to the measurement process.

In some possible embodiments, N is a rounded-up value of a ratio of the maximum reception timing offset to symbol duration.

In some possible embodiments, the step of transmitting no radio information includes none of the following: sending a physical uplink control channel (PUCCH), sending a physical uplink shared channel (PUSCH), sending a sounding reference signal (SRS), receiving a physical downlink control channel (PDCCH), receiving a physical downlink shared channel (PDSCH), receiving a tracking reference signal (TRS), and receiving a channel state information reference signal (CSI-RS) configured for channel quality indication (CQI) feedback.

In the example of the disclosure, the user equipment 101 sends the maximum reception timing offset to the network device 102. Accordingly, the user equipment 101 and the network device 102 determine a rational value of N according to the maximum reception timing offset and determine a first time period that is rational according to the value of N and the reference signal measurement time period. The network device 102 sends no downlink information to the user equipment 101 in the first time period. The user equipment 101 transmits no radio information in the first time period. Thus, inter-symbol interference is effectively avoided.

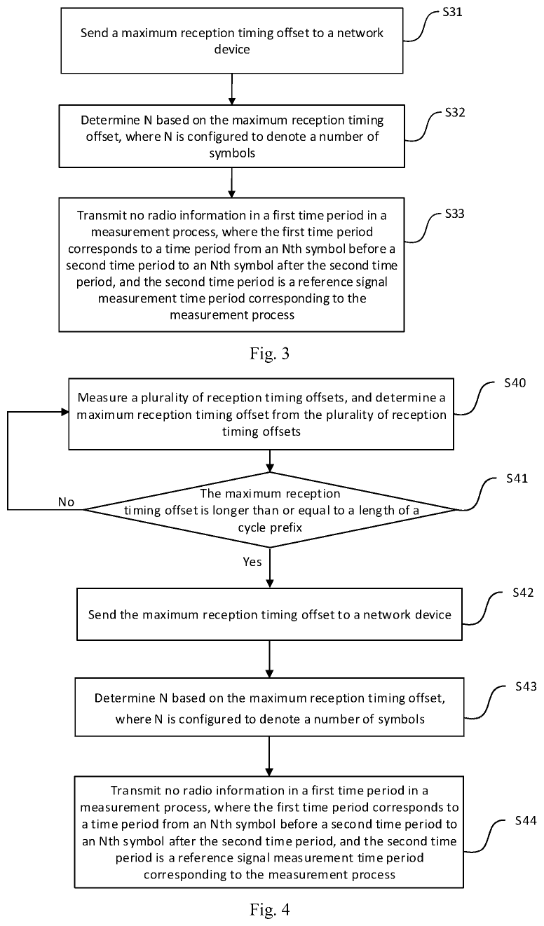

A method for scheduling is provided in an example of the disclosure. The method is applied to the user equipment 101. With reference to FIG. 3, a flowchart of a method for scheduling according to an example is shown. As shown in FIG. 3, the method includes steps S31-S33.
In S31, a maximum reception timing offset is sent to the network device 102.
In S32, N is determined based on the maximum reception timing offset, where N is configured to denote a number of symbols.
In S33, no radio information is transmitted in a first time period in a measurement process, where the first time period corresponds to a time period from an Nth symbol before a second time period to an Nth symbol after the second time period, and the second time period is a reference signal measurement time period corresponding to the measurement process.

In some possible embodiments, N is a rounded-up value of a ratio of the maximum reception timing offset to symbol duration.

In some possible embodiments, the step that “no radio information is transmitted” is performed, such that none of the following are done: sending a PUCCH, sending a PUSCH, sending an SRS, receiving a PDCCH, receiving a PDSCH, receiving a TRS, or receiving a CSI-RS configured for CQI feedback.

In the example of the disclosure, a time period between the Nth symbol before the second time period and a start time of the second time period constitutes a left guard boundary configured to resist an influence from the maximum reception timing offset. A time period between the Nth symbol after the second time period and an end time of the second time period constitutes a right guard boundary configured to resist an influence from the maximum reception timing offset.

Moreover, in the example of the disclosure, the user equipment 101 sends the maximum reception timing offset to the network device 102. Accordingly, the user equipment 101 and the network device 102 determine a rational value of N according to the maximum reception timing offset and determine a first time period that is rational according to the value of N and the reference signal measurement time period. The network device 102 sends no downlink information to the user equipment 101 in the first time period. The user equipment 101 transmits no radio information in the first time period. Thus, inter-symbol interference is effectively avoided.

A method for scheduling is provided in an example of the disclosure. The method is applied to the user equipment 101. In the method, a condition configured to trigger performance of the method for scheduling is that a maximum reception timing offset is longer than or equal to a length of a cycle prefix. The method for scheduling includes steps S31-S33, as shown in FIG. 3.
S31, a maximum reception timing offset is sent to the network device 102.
S32, N is determined based on the maximum reception timing offset, where N is configured to denote a number of symbols.
S33, no radio information is transmitted in a first time period in a measurement process, where the first time period corresponds to a time period from an Nth symbol before a second time period to an Nth symbol after the second time period, and the second time period is a reference signal measurement time period corresponding to the measurement process.

In some possible embodiments, N is a rounded-up value of a ratio of the maximum reception timing offset to symbol duration.

In some possible embodiments, the step that “no radio information is transmitted” is performed such that none of the following are done: sending a PUCCH, sending a PUSCH, sending an SRS, receiving a PDCCH, receiving a PDSCH, receiving a TRS, or receiving a CSI-RS configured for CQI feedback.

In the example of the disclosure, in view of the characteristic that the inter-symbol interference may be caused when a reception or transmission timing offset between serving cells is longer than the length of the cycle prefix, the method for scheduling is performed when the maximum reception timing offset is longer than or equal to the length of the cycle prefix. Thus, a processing capacity of the user equipment is saved on.

A method for scheduling is provided in an example of the disclosure. The method is applied to the user equipment 101. With reference to FIG. 4, a flowchart of a method for scheduling according to an example is shown. As shown in FIG. 4, the method includes steps S40-S44.
S40, a plurality of reception timing offsets are measured, and a maximum reception timing offset is determined from the plurality of reception timing offsets.
S42 to S44 are performed in response to determining that the maximum reception timing offset is longer than or equal to the length of the cycle prefix in S41, i.e., “Yes”. S42 to S44 are not performed in response to determining that the maximum reception timing offset is shorter than the length of the cycle prefix in S41, i.e., “No”. When the answer to S41 is “No”, the method go back to S40.
In S42, the maximum reception timing offset is sent to the network device 102.
In S43, N is determined based on the maximum reception timing offset, where N is configured to denote a number of symbols.
In S44, no radio information is transmitted in a first time period in a measurement process, where the first time period corresponds to a time period from an Nth symbol before a second time period to an Nth symbol after the second time period, and the second time period is a reference signal measurement time period corresponding to the measurement process.

In some possible embodiments, the plurality of reception timing offsets include at least one of: a reception timing offset between a reference serving cell and a non-reference serving cell; or a reception timing offset between different transmission reception points (TRPs).

In some possible embodiments, N is a rounded-up value of a ratio of the maximum reception timing offset to symbol duration.

In some possible embodiments, the step that “no radio information is transmitted” is performed, such that none of the following are done: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 ensures the accuracy of the maximum reception timing offset by measuring the plurality of reception timing offsets and determining the maximum reception timing offset from the plurality of reception timing offsets. Accordingly, the first time period determined is more accurate, and inter-symbol interference is effectively avoided.

A method for scheduling is provided in an example of the disclosure. The method is applied to the user equipment 101 and includes S42a-S44a.
In S42a, a maximum reception timing offset is sent to the network device 102.
In S43a, N is determined based on the maximum reception timing offset, where N is configured to denote a number of symbols.
In S44a, no radio information is transmitted in a time period from an Nth symbol before an SSB-based RRM measurement timing configuration (SMTC) time window to an Nth symbol after the SMTC time window in a process of performing intra-frequency measurement.

In some possible embodiments, before S42a, the method further includes S40a, a plurality of reception timing offsets are measured, and a maximum reception timing offset is determined from the plurality of reception timing offsets. S42a to S44a are performed in response to determining that the maximum reception timing offset is longer than or equal to the length of the cycle prefix, in S41a, i.e., “Yes”. The flow is ended in response to determining that the maximum reception timing offset is shorter than the length of the cycle prefix, in S41a, i.e., “No”.

In some possible embodiments, N is a rounded-up value of a ratio of the maximum reception timing offset to symbol duration.

In some possible embodiments, the step that no radio information is transmitted includes none of the following is performed: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 sends the maximum reception timing offset to the network device 102. Accordingly, the user equipment 101 and the network device 102 determine a rational value of N according to the maximum reception timing offset. The network device 102 determines a first time period that is more rational according to the SMTC time window and the value of N. The network device 102 transmits no downlink information to the user equipment 101 in the first time period in the process of performing the intra-frequency measurement by the user equipment 101. The user equipment 101 sends no radio information in the first time period. Thus, inter-symbol interference is effectively avoided.

A method for scheduling is provided in an example of the disclosure. The method is applied to the user equipment 101 and includes S42b-S44b.
S42b, a maximum reception timing offset is sent to the network device.
S43b, N is determined based on the maximum reception timing offset, where N is configured to denote a number of symbols.
S44b, no radio information is transmitted in a time period from an Nth symbol before a radio link monitoring reference signal (RLM-RS) time window to an Nth symbol after the RLM-RS time window in a process of performing radio link monitoring (RLM) measurement.

In some possible embodiments, before S42b, the method further includes S40b, a plurality of reception timing offsets are measured, and a maximum reception timing offset is determined from the plurality of reception timing offsets. S42b to S44b are performed in response to determining that the maximum reception timing offset is longer than or equal to the length of the cycle prefix, in S41b, i.e., “Yes”. The flow is ended in response to determining that the maximum reception timing offset is shorter than the length of the cycle prefix, in S41b, i.e., “No”.

In some possible embodiments, N is a rounded-up value of a ratio of the maximum reception timing offset to symbol duration.

In some possible embodiments, the step that “no radio information is transmitted” is performed, such that none of the following are performed: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 sends the maximum reception timing offset to the network device 102. Accordingly, the user equipment 101 and the network device 102 determine a rational value of N according to the maximum reception timing offset. The network device 102 determines a first time period that is more rational according to the RLM-RS time window and the value of N. The network device 102 transmits no downlink information to the user equipment 101 in the first time period in the process of performing the RLM measurement by the user equipment 101. The user equipment 101 sends no radio information in the first time period. Thus, inter-symbol interference is effectively avoided.

A method for scheduling is provided in an example of the disclosure. The method is applied to the user equipment 101 and includes S42c-S44c.
In S42c, a maximum reception timing offset is sent to the network device.
In S43c, N is determined based on the maximum reception timing offset, where N is configured to denote a number of symbols.
In S44c, no radio information is transmitted in a time period from an Nth symbol before a beam failure detection reference signal (BFD-RS) time window to an Nth symbol after the BFD-RS time window in a process of performing beam failure detection (BFD) measurement.

In some possible embodiments, before S42c, the method further includes S40c, a plurality of reception timing offsets are measured, and a maximum reception timing offset is determined from the plurality of reception timing offsets. S42c to S44c are performed in response to determining that the maximum reception timing offset is longer than or equal to the length of the cycle prefix, in S41c, i.e., “Yes”. The flow is ended in response to determining that the maximum reception timing offset is shorter than the length of the cycle prefix, in S41c, i.e., “No”.

In some possible embodiments, N is a rounded-up value of a ratio of the maximum reception timing offset to symbol duration.

In some possible embodiments, the step that “no radio information is transmitted” is performed, such that none of the following are done: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 sends the maximum reception timing offset to the network device 102. Accordingly, the user equipment 101 and the network device 102 determine a rational value of N according to the maximum reception timing offset. The network device 102 determines a first time period that is more rational according to the BFD-RS time window and the value of N. The network device 102 transmits no downlink information to the user equipment 101 in the first time period in the process of performing the BFD measurement by the user equipment 101. The user equipment 101 sends no radio information in the first time period. Thus, inter-symbol interference is effectively avoided.

A method for scheduling is provided in an example of the disclosure. The method is applied to the user equipment 101 and includes S42d-S44d.
S42d, a maximum reception timing offset is sent to the network device.
S43d, N is determined based on the maximum reception timing offset, where N is configured to denote a number of symbols.
S44d, no radio information is transmitted in a time period from an Nth symbol before a candidate beam detection reference signal (CBD-RS) time window to an Nth symbol after the CBD-RS time window in a process of performing candidate beam detection (CBD) measurement.

In some possible embodiments, before S42d, the method further includes S40d, a plurality of reception timing offsets are measured, and a maximum reception timing offset is determined from the plurality of reception timing offsets. S42d to S44d are performed in response to determining that the maximum reception timing offset is longer than or equal to the length of the cycle prefix, in S41d, i.e., “Yes”. The flow is ended in response to determining that the maximum reception timing offset is shorter than the length of the cycle prefix, in S41d, i.e., “No”.

In some possible embodiments, N is a rounded-up value of a ratio of the maximum reception timing offset to symbol duration.

In some possible embodiments, the step that “no radio information is transmitted” is performed, such that none of the following are done: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 sends the maximum reception timing offset to the network device 102. Accordingly, the user equipment 101 and the network device 102 determine a rational value of N according to the maximum reception timing offset. The network device 102 determines a first time period that is more rational according to the CBD-RS time window and the value of N. The network device 102 transmits no downlink information to the user equipment 101 in the first time period in the process of performing the CBD measurement by the user equipment 101. The user equipment 101 sends no radio information in the first time period. Thus, inter-symbol interference is effectively avoided.

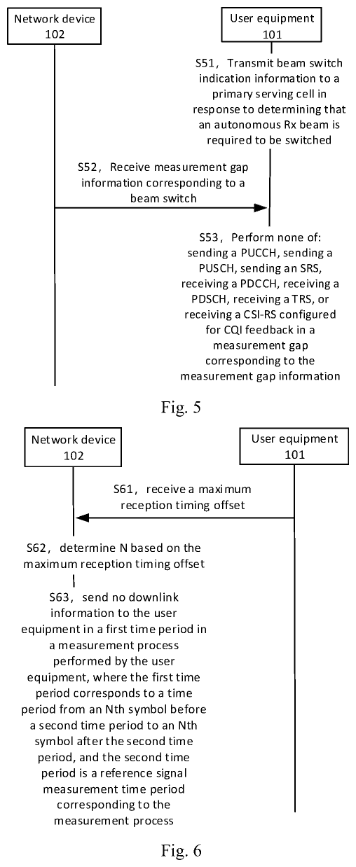

A method for scheduling is provided in an example of the disclosure. The method is applied to the user equipment 101. With reference to FIG. 5, a flowchart of a method for scheduling according to an example is shown. As shown in FIG. 5, the method includes steps S51-S53.
In S51, beam switch indication information is sent to a primary serving cell in response to determining that an autonomous Rx beam is needed to be switched.
In S52, measurement gap information corresponding to a beam switch is received from the network device 102.
In S53, none of the following is performed: sending a PUCCH, sending a PUSCH, sending an SRS, receiving a PDCCH, receiving a PDSCH, receiving a TRS, or receiving a CSI-RS configured for CQI feedback in a measurement gap corresponding to the measurement gap information.

In some possible embodiments, S51-S53 are performed after the method in each example previously described here.

In some possible embodiments, the beam switch indication information includes at least one of: beam switch start time information and beam switch duration information.

In the example of the disclosure, the user equipment 101 sends the beam switch indication information to the network device 102. Accordingly, the network device 102 feeds back the measurement gap information corresponding to the beam switch after receiving the beam switch indication information. The user equipment 101 performs no corresponding operations of sending a signal and receiving a signal in the measurement gap corresponding to the measurement gap information. Thus, inter-symbol interference is effectively avoided.

A method for scheduling is provided in an example of the disclosure. The method is applied to the network device 102. With reference to FIG. 6, a flowchart of a method for scheduling according to an example is shown. As shown in FIG. 6, the method includes steps S61-S63.
In S61, a maximum reception timing offset is received from the user equipment 101.
In S62, N is determined based on the maximum reception timing offset, where N is configured to denote a number of symbols.
In S63, no downlink information is sent to the user equipment in a first time period in a measurement process performed by the user equipment 101, where the first time period corresponds to a time period from an Nth symbol before a second time period to an Nth symbol after the second time period, and the second time period is a reference signal measurement time period corresponding to the measurement process.

In some possible embodiments, N is a rounded-up value of a ratio of the maximum reception timing offset to symbol duration.

In some possible embodiments, the step that “no radio information is transmitted” includes none of: sending a PUCCH, sending a PUSCH, sending an SRS, receiving a PDCCH, receiving a PDSCH, receiving a TRS, or receiving a CSI-RS configured for CQI feedback is performed.

In the example of the disclosure, a time period between the Nth symbol before the second time period and a start time of the second time period constitutes a left guard boundary configured to resist an influence from the maximum reception timing offset. A time period between the Nth symbol after the second time period and an end time of the second time period constitutes a right guard boundary configured to resist an influence from the maximum reception timing offset.

Moreover, in the example of the disclosure, the user equipment 101 sends the maximum reception timing offset to the network device 102. Accordingly, the user equipment 101 and the network device 102 determine a rational value of N according to the maximum reception timing offset and determine a first time period that is rational according to the value of N and the reference signal measurement time period. The network device 102 transmits no downlink information to the user equipment 101 in the first time period. The user equipment 101 sends no radio information in the first time period. Thus, inter-symbol interference is effectively avoided.

A method for scheduling is provided in an example of the disclosure. The method is applied to the network device 102 and includes S61a-S63a.
In S61a, a maximum reception timing offset is received from the user equipment 101.
In S62a, N is determined based on the maximum reception timing offset, where N is configured to denote a number of symbols.
In S63a, no downlink information is sent to the user equipment in a time period from an Nth symbol before an SSB-based RRM SMTC time window to an Nth symbol after the SMTC time window in a process by performing intra-frequency measurement by the user equipment 101.

In some possible embodiments, N is a rounded-up value of a ratio of the maximum reception timing offset to symbol duration.

In some possible embodiments, the step that “no radio information is transmitted” includes none of the following: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 sends the maximum reception timing offset to the network device 102. Accordingly, the user equipment 101 and the network device 102 determine a rational value of N according to the maximum reception timing offset. The network device 102 determines a first time period that is more rational according to the SMTC time window and the value of N. The network device 102 transmits no downlink information to the user equipment 101 in the first time period in the process of performing the intra-frequency measurement by the user equipment 101. The user equipment 101 sends no radio information in the first time period. Thus, inter-symbol interference is effectively avoided.

A method for scheduling is provided in an example of the disclosure. The method is applied to the network device 102 and includes S61b-S63b.
In S61b, a maximum reception timing offset is received from the user equipment 101.
In S62b, N is determined based on the maximum reception timing offset, where N is configured to denote a number of symbols.
In S63b, no downlink information is sent to the user equipment in a time period from an Nth symbol before a radio link monitoring reference signal (RLM-RS) time window to an Nth symbol after the RLM-RS time window in a process of performing radio link monitoring (RLM) measurement by the user equipment 101.

In some possible embodiments, N is a rounded-up value of a ratio of the maximum reception timing offset to symbol duration.

In some possible embodiments, the step that “no radio information is transmitted” includes none of the following: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 sends the maximum reception timing offset to the network device 102. Accordingly, the user equipment 101 and the network device 102 determine a rational value of N according to the maximum reception timing offset. The network device 102 determines a first time period that is more rational according to the RLM-RS time window and the value of N. The network device 102 transmits no downlink information to the user equipment 101 in the first time period in the process of performing the RLM measurement by the user equipment 101. The user equipment 101 sends no radio information in the first time period. Thus, inter-symbol interference is effectively avoided.

A method for scheduling is provided in an example of the disclosure. The method is applied to the network device 102 and includes S61c-63c.
In S61c, a maximum reception timing offset is received from the user equipment 101.
In S62c, N is determined based on the maximum reception timing offset, where N is configured to denote a number of symbols.
In S63c, no downlink information is sent to the user equipment in a time period from an Nth symbol before a beam failure detection reference signal (BFD-RS) time window to an Nth symbol after the BFD-RS time window in a process of performing beam failure detection (BFD) measurement by the user equipment 101.

In some possible embodiments, N is a rounded-up value of a ratio of the maximum reception timing offset to symbol duration.

In some possible embodiments, the step that “no radio information is transmitted” includes none of the following: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 sends the maximum reception timing offset to the network device 102. Accordingly, the user equipment 101 and the network device 102 determine a rational value of N according to the maximum reception timing offset. The network device 102 determines a first time period that is more rational according to the BFD-RS time window and the value of N. The network device 102 transmits no downlink information to the user equipment 101 in the first time period in the process of performing the BFD measurement by the user equipment 101. The user equipment 101 sends no radio information in the first time period. Thus, inter-symbol interference is effectively avoided.

A method for scheduling is provided in an example of the disclosure. The method is applied to the network device 102 and includes S61d-S63d.
In S61d, a maximum reception timing offset is received from the user equipment 101.
In S62d, N is determined based on the maximum reception timing offset, where N is configured to denote a number of symbols.
In S63d, no downlink information is sent to the user equipment in a time period from an Nth symbol before a candidate beam detection reference signal (CBD-RS) time window to an Nth symbol after the CBD-RS time window in a process of performing candidate beam detection (CBD) measurement by the user equipment 101.

In some possible embodiments, N is a rounded-up value of a ratio of the maximum reception timing offset to symbol duration.

In some possible embodiments, the step that “no radio information is transmitted” includes none of the following: sending a PUCCH, sending a PUSCH, sending an SRS, receiving a PDCCH, receiving a PDSCH, receiving a TRS, or receiving a CSI-RS configured for CQI feedback.

In the example of the disclosure, the user equipment 101 sends the maximum reception timing offset to the network device 102. Accordingly, the user equipment 101 and the network device 102 determine a rational value of N according to the maximum reception timing offset. The network device 102 determines a first time period that is more rational according to the CBD-RS time window and the value of N. The network device 102 transmits no downlink information to the user equipment 101 in the first time period in the process of performing the CBD measurement by the user equipment 101. The user equipment 101 sends no radio information in the first time period. Thus, inter-symbol interference is effectively avoided.

A method for scheduling is provided in an example of the disclosure. The method is applied to the network device 102 and includes receiving beam switch indication information and sending measurement gap information.

The beam switch indication information sent by the user equipment 101 is received.

The measurement gap information corresponding to a beam switch is sent to the user equipment 101, and in a measurement gap corresponding to the measurement gap information, none of: sending a PUCCH, sending a PUSCH, sending an SRS, receiving a PDCCH, receiving a PDSCH, receiving a TRS, or receiving a CSI-RS configured for CQI feedback is performed by the user equipment 101.

In some possible embodiments, the beam switch indication information includes at least one of: beam switch start time information or beam switch duration information.

In the example of the disclosure, the user equipment 101 sends the beam switch indication information to the network device 102. Accordingly, the network device 102 feeds back the measurement gap information corresponding to the beam switch after receiving the beam switch indication information. The user equipment 101 performs no corresponding operations of sending a signal and receiving a signal in the measurement gap corresponding to the measurement gap information. Thus, inter-symbol interference is effectively avoided.

A method for scheduling is provided in an example of the disclosure. The method is applied to the network device 102 and includes receiving beam switch indication information, determining and sending measurement gap information.

The beam switch indication information sent by the user equipment 101 is received. The beam switch indication information includes at least one of: beam switch start time information or beam switch duration information.

The measurement gap information corresponding to a beam switch is determined based on the beam switch indication information.

The measurement gap information corresponding to the beam switch is sent to the user equipment 101, and in a measurement gap corresponding to the measurement gap information, none of: sending a PUCCH, sending a PUSCH, sending an SRS, receiving a PDCCH, receiving a PDSCH, receiving a TRS, or receiving a CSI-RS configured for CQI feedback is performed by the user equipment 101.

In the example of the disclosure, the user equipment 101 sends the beam switch indication information to the network device 102. Accordingly, the network device 102 feeds back the measurement gap information corresponding to the beam switch after receiving the beam switch indication information. The user equipment 101 performs no corresponding operations of sending a signal and receiving a signal in the measurement gap corresponding to the measurement gap information. Thus, inter-symbol interference is effectively avoided.

Based on the same concept as that in the above method example, a communication apparatus is further provided in an example of the disclosure. The communication apparatus may have a function of user equipment in the above method example and may be configured to perform steps performed by the user equipment and provided in the above method example. The function may be implemented through hardware or software, or by executing corresponding software by hardware. The hardware or software includes one or more modules corresponding to the above function.

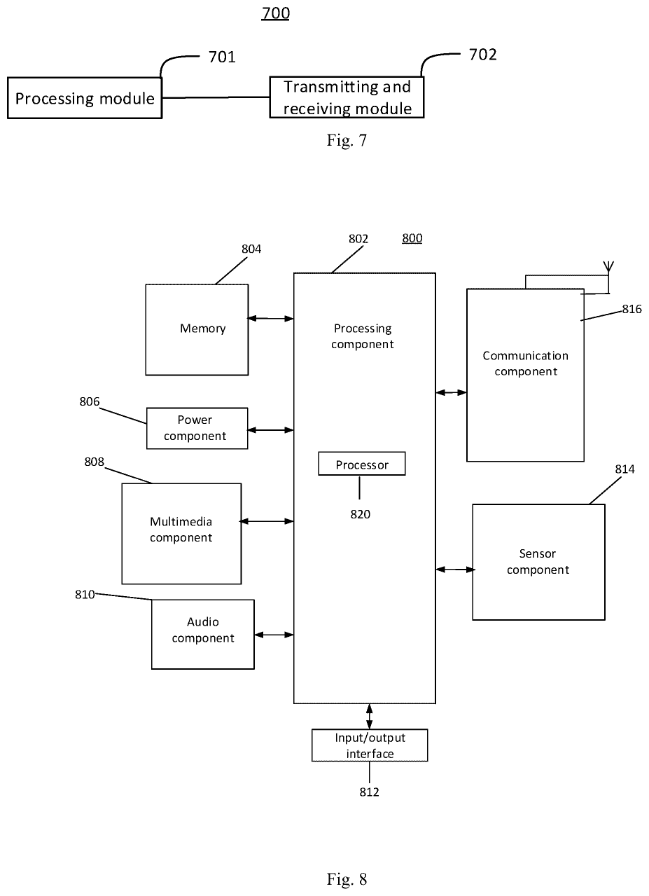

In a possible embodiment, the communication apparatus 700 shown in FIG. 7 may serve as the user equipment involved in the above method example and perform the steps performed by the user equipment in the above method example. As shown in FIG. 7, the communication apparatus 700 may include a transmitting and receiving module 702 and a processing module 701. The transmitting and receiving module 702 and the processing module 701 are coupled to each other. The transmitting and receiving module 702 may be configured to support the communication apparatus 700 in communication. The transmitting and receiving module 702 may have a radio communication function of performing radio communication with other communication apparatuses through a radio air interface, etc. The processing module 701 may be configured to support the communication apparatus 700 in performing processing actions in the above method example, including, but not limited to, generating information and messages to be sent by the transmitting and receiving module 702, and/or demodulating and decoding signals received by the transmitting and receiving module 702, etc.

In an instance, the transmitting and receiving module 702 is configured to send a maximum reception timing offset to the network device when performing the steps implemented by the user equipment. The processing module 701 is configured to determine N based on the maximum reception timing offset, where N is configured to denote a number of symbols; and configured to transmit no radio information in a first time period in a measurement process, where the first time period corresponds to a time period from an Nth symbol before a second time period to an Nth symbol after the second time period, and the second time period is a reference signal measurement time period corresponding to the measurement process.

When being the user equipment, the communication apparatus may also be structurally shown in FIG. 8. The apparatus 800 may be a mobile phone, a computer, a digital broadcast terminal, a messaging device, a gaming console, a tablet device, a medical device, a fitness device, a personal digital assistant, etc.

With reference to FIG. 8, the apparatus 800 may include one or more of the following components: a processing component 802, a memory 804, a power component 806, a multimedia component 808, an audio component 810, an input/output (I/O) interface 812, a sensor component 814, and a communication component 816.

Generally, the processing component 802 controls an overall operation of the apparatus 800, such as operations associated with display, telephone calls, data communication, a camera operation, and a recording operation. The processing component 802 may include one or more processors 820 to complete all or some steps of the above method by execute an instruction. In addition, the processing component 802 may include one or more modules, so as to facilitate interaction between the processing component 802 and other components. For example, the processing component 802 may include a multimedia module, so as to facilitate interaction between the multimedia component 808 and the processing component 802.

The memory 804 is configured to support the operations at the apparatus 800 by storing various types of data. Instances of these data include an instruction configured for any application or method operating on the apparatus 800, contact data, phone book data, a message, a picture, a video, etc. The memory 804 may be implemented by any type of volatile or non-volatile storage devices or their combinations, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 806 provides power for various components of the apparatus 800. The power component 806 may include a power source management system, one or more power sources, and other components associated with power generation, management, and distribution for the apparatus 800.

The multimedia component 808 includes a screen that provides an output interface between the apparatus 800 and a user. In some examples, the screen may include a liquid crystal display (LCD) and a touch panel (TP). If including the touch panel, the screen may be implemented as a touch screen, so as to receive an input signal from the user. The touch panel includes one or more touch sensors to sense touches, swipes, and gestures on the touch panel. The touch sensor may measure duration and a pressure associated with a touch or swipe operation while sensing a boundary of the touch or swipe action. In some examples, the multimedia component 808 includes a front-facing camera and/or a rear-facing camera. When the apparatus 800 is in an operation mode, such as a photographing mode or a video mode, the front-facing camera and/or the rear-facing camera may receive external multimedia data. Each of the front-facing camera and the rear-facing camera may be a fixed optical lens system or have a focal length and an optical zoom capability.

The audio component 810 is configured to output and/or input audio signals. For example, the audio component 810 includes a microphone (MIC) configured to receive external audio signals when the apparatus 800 is in the operation mode, for example, a calling mode, a recording mode, and a speech recognition mode. The audio signals received may be further stored in the memory 804 or sent via the communication component 816. In some examples, the audio component 810 further includes a speaker configured to output the audio signal.

The I/O interface 812 provides an interface between the processing component 802 and a peripheral interface module. The above peripheral interface module may be a keyboard, a click wheel, a button, etc. These buttons may include, but are not limited to, a home button, a volume button, a start button, and a lock button.

The sensor component 814 includes one or more sensors configured to provide state assessments for various aspects of the apparatus 800. For example, the sensor component 814 may detect an on/off state of the apparatus 800, and relative positioning of the components. For example, the components are a display and a keypad of the apparatus 800. The sensor component 814 may also detect a change in position of the apparatus 800 or one component of the apparatus 800, the presence or absence of contact between the user and the apparatus 800, an orientation or an acceleration/deceleration of the apparatus 800, and a change in temperature of the apparatus 800. The sensor component 814 may include a proximity sensor configured to detect the presence of a nearby object in the absence of any physical contact. The sensor component 814 may further include a light sensor, such as CMOS or CCD image sensor configured to be used in imaging application. In some examples, the sensor component 814 may further include an acceleration sensor, a gyroscope sensor, a magnetic sensor, a pressure sensor, or a temperature sensor.

The communication component 816 is configured to facilitate wired or radio communication between the apparatus 800 and other devices. The apparatus 800 may access a radio network based on a communication standard, such as a wireless fidelity (Wi-Fi) network, a 4th-generation (4G) network or a 5G network, or their combinations. In an example, the communication component 816 receives a broadcast signal or broadcast related information from an external broadcast management system via a broadcast channel. In an example, the communication component 816 further includes a near field communication (NFC) module to facilitate short-distance communication. For example, the NFC module may be implemented based on a radio frequency identification (RFID) technology, an infrared data association (IrDA) technology, an ultra wide band (UWB) technology, a Bluetooth (BT) technology, etc.

In an example, the apparatus 800 may be configured to perform the above method by being implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, etc.

A non-transitory computer-readable storage medium including an instruction, for example, a memory 804 including an instruction is further provided in an example. The above instruction may complete the above method by being performed by a processor 820 of an apparatus 800. For example, the non-transitory computer-readable storage medium may be an ROM, a random access memory (RAM), a compact disk (CD)-ROM, a magnetic tape, a floppy disk, an optical data storage device, etc.

Based on the same concept as that in the above method example, a communication apparatus is further provided in an example of the disclosure. The communication apparatus may have a function of network device in the above method example and may be configured to perform steps performed by the network device and provided in the above method example. The function may be implemented through hardware or software, or by executing corresponding software by hardware. The hardware or software includes one or more modules corresponding to the above function.

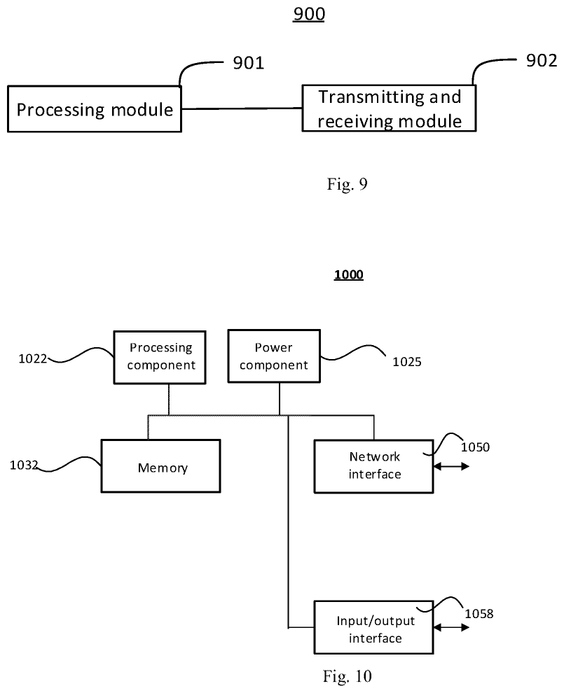

In a possible embodiment, the communication apparatus 900 shown in FIG. 9 may serve as the network device involved in the above method example and perform the steps performed by the network device in the above method example. As shown in FIG. 9, the communication apparatus 900 may include a transmitting and receiving module 902 and a processing module 901. The transmitting and receiving module 902 and the processing module 901 are coupled to each other. The transmitting and receiving module 902 may be configured to support the communication apparatus 900 in communication. The transmitting and receiving module 902 may have a radio communication function of performing radio communication with other communication apparatuses through a radio air interface, etc. The processing module 901 may be configured to support the communication apparatus 900 in performing processing actions in the above method example, including, but not limited to, generating information and messages to be sent by the transmitting and receiving module 902, and/or demodulating and decoding signals received by the transmitting and receiving module 902, etc.

In an instance, when the steps implemented by the network device are performed, the transmitting and receiving module 902 is configured to receive a maximum reception timing offset from user equipment. The processing module 901 is configured to determine N based on the maximum reception timing offset, where N is configured to denote a number of symbols; and configured to send no downlink information to the user equipment in a first time period in a measurement process performed by the user equipment, where the first time period corresponds to a time period from an Nth symbol before a second time period to an Nth symbol after the second time period, and the second time period is a reference signal measurement time period corresponding to the measurement process.

When being the network device, the communication apparatus may also be structurally shown in FIG. 10. The communication apparatus is structurally described with the base station as an example. As shown in FIG. 10, the apparatus 1000 includes a memory 1032, a processing component 1022, a network interface 1050, a power component 1025, and input/output interface 1058. The memory 1032 is coupled to the processing component 1022 and may be configured to store programs and data needed for the communication apparatus 1000 to implement various functions. The processing component 1022, for example a CPU, is configured to support the communication apparatus 1000 in performing corresponding functions in the above method. The functions may be implemented by invoking the programs stored in the memory 1032. The network interface 1050 may be a radio transceiver and may be configured to support the communication apparatus 1000 in receiving signaling and/or data and sending signaling and/or data through a radio air interface. The network interface 1050 may also be referred to as a transmitting and receiving unit or a communication unit. The network interface 1050 may include a radio frequency component and one or more antennas. The radio frequency component may be a remote radio unit (RRU) and may be specifically configured to transmit a radio frequency signal and configured for conversion between a radio frequency signal and a baseband signal. One or more antennas may be specifically configured to radiate and receive the radio frequency signal.

When the communication apparatus 1000 is needed to send data, the processing component 1022 may perform baseband processing on the data to be sent and output a baseband signal to the radio frequency unit. The radio frequency unit may perform radio frequency processing on the baseband signal and send a radio frequency signal in a form of electromagnetic waves through the antenna. When data are to be sent to the communication apparatus 1000, the radio frequency unit may receive a radio frequency signal through the antenna, convert the radio frequency signal into a baseband signal, and output the baseband signal to the processing component 1022. The processing component 1022 may convert the baseband signal into data and process the data.

A non-transitory computer-readable storage medium including an instruction, for example, a memory 1032 including an instruction is further provided in an example. The above instruction may complete the above method by being performed by a processing component 1022 of an apparatus 1000. For example, the non-transitory computer-readable storage medium may be an ROM, a random access memory (RAM), a compact disk (CD)-ROM, a magnetic tape, a floppy disk, an optical data storage device, etc.

Those skilled in the art will readily conceive of other embodiments of the examples of the disclosure after considering the description and practicing the invention disclosed here. The disclosure is intended to cover any variations, uses, or adaptive changes in the examples of the disclosure that follow the general principles in the examples of the disclosure and include common general knowledge or customary technical means in the art not disclosed in the disclosure. The description and the examples are merely deemed illustrative, and the true scope and spirit in the examples of the disclosure are indicated by the following claims.

It should be understood that the examples of the disclosure are not limited to precise structures that have been described above and shown in the accompanying drawings, and various modifications and changes can be made without departing from the scope of the disclosure. The scope in the examples of the disclosure is limited merely by the appended claims.

### INDUSTRIAL APPLICABILITY

The user equipment sends the maximum reception timing offset to the network device. Thus, the user equipment and the network device determine the rational value of N according to the maximum reception timing offset and determine the first time period that is rational according to the value of N and the reference signal measurement time period. The network device sends no downlink information to the user equipment in the first time period. The user equipment transmits no radio information in the first time period. Thus, inter-symbol interference is effectively avoided.

1. A method for scheduling, performed by a user equipment and comprising:
sending a maximum reception timing offset to a network device;
determining N based on the maximum reception timing offset, wherein N is configured to denote a number of symbols; and
transmitting no radio information in a first time period in a measurement process, wherein the first time period corresponds to a time period from an Nth symbol before a second time period to an Nth symbol after the second time period, and the second time period is a reference signal measurement time period corresponding to the measurement process.

2. The method according to claim 1, wherein a condition configured to trigger performance of the method for scheduling is that the maximum reception timing offset is longer than or equal to a length of a cycle prefix.

3. The method according to claim 2, further comprising:
measuring a plurality of reception timing offsets, and determining a maximum of the plurality of reception timing offsets as the maximum reception timing offset; wherein
the plurality of reception timing offsets comprise at least one of:
a reception timing offset between a reference serving cell and a non-reference serving cell; or
a reception timing offset between different transmission reception points.

4. The method according to claim 1, wherein transmitting no radio information in the first time period in the measurement process comprises any one or more of:
transmitting no radio information in a time period from an Nth symbol before an SSB-based RRM measurement timing configuration (SMTC) time window to an Nth symbol after the SMTC time window in a process of performing intra-frequency measurement;
transmitting no radio information in a time period from an Nth symbol before a radio link monitoring reference signal (RLM-RS) time window to an Nth symbol after the RLM-RS time window in a process of performing radio link monitoring (RLM) measurement;
transmitting no radio information in a time period from an Nth symbol before a beam failure detection reference signal (BFD-RS) time window to an Nth symbol after the BFD-RS time window in a process of performing beam failure detection (BFD) measurement; or
transmitting no radio information in a time period from an Nth symbol before a candidate beam detection reference signal (CBD-RS) time window to an Nth symbol after the CBD-RS time window in a process of performing candidate beam detection (CBD) measurement.

5-7. (canceled)

8. The method according to claim 1, wherein transmitting no radio information comprises performing none of:
sending a physical uplink control channel (PUCCH), sending a physical uplink shared channel (PUSCH), sending a sounding reference signal (SRS), receiving a physical downlink control channel (PDCCH), receiving a physical downlink shared channel (PDSCH), receiving a tracking reference signal (TRS), or receiving a channel state information reference signal (CSI-RS) configured for channel quality indication (CQI) feedback.

9. The method according to claim 1, wherein N is a rounded-up value of a ratio of the maximum reception timing offset to symbol duration.

10. The method according to claim 1, further comprising:
sending beam switch indication information to a primary serving cell; and
receiving measurement gap information corresponding to a beam switch from the network device, and in a measurement gap corresponding to the measurement gap information, performing none of:
sending a PUCCH, sending a PUSCH, sending an SRS, receiving a PDCCH, receiving a PDSCH, receiving a TRS, or receiving a CSI-RS configured for CQI feedback.

11. The method according to claim 10, wherein the beam switch indication information comprises at least one of:
beam switch start time information or beam switch duration information.

12. A method for scheduling, performed by a network device and comprising:
receiving a maximum reception timing offset from user equipment;
determining N based on the maximum reception timing offset, wherein N is configured to denote a number of symbols; and
sending no downlink information to the user equipment in a first time period in a measurement process performed by the user equipment, wherein the first time period corresponds to a time period from an Nth symbol before a second time period to an Nth symbol after the second time period, and the second time period is a reference signal measurement time period corresponding to the measurement process.

13. The method according to claim 12, wherein sending no downlink information to the user equipment in the first time period in the measurement process performed by the user equipment comprises any one or more of:
sending no downlink information to the user equipment in a time period from an Nth symbol before an SSB-based RRM SMTC time window to an Nth symbol after the SMTC time window in a process of performing intra-frequency measurement by the user equipment;
sending no downlink information to the user equipment in a time period from an Nth symbol before a radio link monitoring reference signal (RLM-RS) time window to an Nth symbol after the RLM-RS time window in a process of performing radio link monitoring (RLM) measurement by the user equipment;
sending no downlink information to the user equipment in a time period from an Nth symbol before a beam failure detection reference signal (BFD-RS) time window to an Nth symbol after the BFD-RS time window in a process of performing beam failure detection (BFD) measurement by the user equipment; or
sending no downlink information to the user equipment in a time period from an Nth symbol before a candidate beam detection reference signal (CBD-RS) time window to an Nth symbol after the CBD-RS time window in a process of performing candidate beam detection (CBD) measurement by the user equipment.

14-16. (canceled)

17. The method according to claim 12, wherein sending no downlink information comprises performing none of:
sending a PDCCH, sending a PDSCH, sending a TRS, or sending a CSI-RS configured for CQI feedback.

18. The method according to claim 12, wherein N is a rounded-up value of a ratio of the maximum reception timing offset to symbol duration.

19. The method according to claim 12, further comprising:
receiving beam switch indication information sent by the user equipment; and
sending measurement gap information corresponding to a beam switch to the user equipment.

20. The method according to claim 19, wherein the beam switch indication information comprises at least one of:
beam switch start time information or beam switch duration information.

21. The method according to claim 20, further comprising:
determining the measurement gap information corresponding to the beam switch based on the beam switch indication information.

22-23. (canceled)

24. A communication apparatus, comprising:
a memory configured to store a computer program; and
a processor configured to:
send a maximum reception timing offset to a network device;
determine N based on the maximum reception timing offset, wherein N is configured to denote a number of symbols; and
transmit no radio information in a first time period in a measurement process, wherein the first time period corresponds to a time period from an Nth symbol before a second time period to an Nth symbol after the second time period, and the second time period is a reference signal measurement time period corresponding to the measurement process.

25. A communication apparatus, comprising: a processor and a memory; wherein
the memory is configured to store a computer program; and
the processor is configured to implement the method according to claim 12 by executing the computer program.

26. A non-transitory computer-readable storage medium, storing an instruction, wherein in response to being invoked and executed on a computer, the instruction causes the computer to perform the method according to claim 1.

27. A non-transitory computer-readable storage medium, storing an instruction, wherein in response to being invoked and executed on a computer, the instruction causes the computer to perform the method according to claim 12.
